(19) United States
(12) Patent Application Publication
(10) Pub. No.: US 2010/0187213 A1
(43) Pub. Date: Jul. 29, 2010

(54) THERAPEUTIC MAT

(76) Inventor: Keith D. Cheatham, II, Girard, OH (US)

Correspondence Address: RANKIN, HILL & CLARK LLP, 38210 GLENN AVENUE, WILLOUGHBY, OH, 44094-7808, US

(21) Appl. No.: 12/693,764

(22) Filed: Jan. 26, 2010

Related U.S. Application Data
(60) Provisional application No. 61/147,155, filed on Jan. 26, 2009.

(51) Int. Cl. B60L 1/02; A61H 1/00

(52) U.S. Cl. 219/202; 601/18

(57) ABSTRACT

A therapeutic mat is described. The mat provides therapeutic relief in the form of vibratory motion and/or heat. The mat or pad is particularly useful as a floor mat in a vehicle. The mat includes provisions to enable powering the mat from a 12 volt direct current source, such as used in an automobile or other vehicle. A massage module can be removed from the mat to facilitate cleaning of the mat. The mat may also include one or more upwardly extending provisions for massaging the arch region of a user's feet.

### CROSS REFERENCES TO RELATED APPLICATIONS

This application claims priority upon U.S. provisional application Ser. No. 61/147,155 filed Jan. 26, 2009.

### FIELD OF THE INVENTION

The present invention relates to a therapeutic mat. The mat or pad may be in various forms such as a floor mat, a seat bottom, and a seat back. The mat or pad provides therapeutic relief in the form of vibratory motion and/or heat.

### BACKGROUND OF THE INVENTION

A wide variety of mats are known in the art. Many mats include vibrating elements for massaging and/or heating elements. Although such mats may be useful, problems arise if the mat requires cleaning or is otherwise immersed in liquid. Prolonged exposure to liquids such as cleaning water can damage electronic components and particularly, sensitive circuitry and vibrating components incorporated in the mat.

Massaging mats are typically provided with a large number of outwardly extending projections or “fingers”. When a user presses against such mats, the “fingers” provide increased pressure at their points of contact with the user, thereby providing a pleasant feeling to the user. Although satisfactory in many regards, these mats typically have limited application since the projections are unable to reach certain regions of a user such as arches along the underside of a user's feet.

In view of the foregoing, a need exists for a therapeutic mat which can be easily cleaned and/or immersed in a cleaning liquid without the potential for damage. In addition, a need exists for an improved therapeutic mat which provides increased therapeutic benefits.

### SUMMARY OF THE INVENTION

The difficulties and drawbacks associated with previously known mats are overcome in the present apparatus for a therapeutic mat having a massager module that can be selectively removed from the mat. The mat also includes one or more outwardly projecting members that transmit vibratory motion to the user.

In one aspect, the present invention provides a vehicle floor mat comprising a thin, planar, flexible member defining an upwardly directed first face, an oppositely directed second face, and an interior hollow region between at least a portion of the first face and the second face. The first face defines at least one raised region. The flexible member is sized and shaped to reside along the floor of a vehicle cabin. The mat also comprises a massager module disposed in the interior hollow region of the flexible member. The module emits vibratory motion upon application of electrical power to the module. The mat further comprises a control unit for controlling the operation of the massager module. And, the mat additionally comprises an electrically conductive cord extending between the massager module and the control unit. The massager module includes at least one outwardly extending member that directs vibratory motion to the at least one raised region of the first face of the flexible member.

In another aspect, the invention provides an electrically powered therapeutic mat comprising a thin, planar, flexible member defining a first upwardly directed face and a second oppositely directed face. The flexible member further defines a hollow interior region between at least a portion of the first face and at least a portion of the second face. The flexible member includes an assembly providing selective access to the interior region from one or both of the faces. The flexible member further includes at least one upwardly extending projection along the first face of the flexible member. The mat also comprises a massager module disposed in the interior region defined in the flexible member. The mat additionally comprises a heating element disposed in at least a portion of the flexible member. And, the mat comprises a control unit in communication with both the massager module and the heating element and configured for controlling the operation of each of the massager module and the heating element.

In yet another aspect, the invention provides a mat adapted for placement on a vehicle seat. The mat comprises a thin, planar, flexible member sized and shaped to conform and be positioned on a vehicle seat. The flexible member defines a seat portion for placement on a seat cushion of the vehicle seat and a back portion for placement on a back cushion of the vehicle seat. The member defines a selectively accessible interior hollow region in at least one of the seat portion and the back portion of the flexible member. The mat further comprises at least one massager module disposed in the at least one interior hollow region defined in the flexible member. The module emits vibratory motion upon application of electrical power to the module. The mat also comprises a control unit for controlling the operation of the at least one massager module. And, the mat further comprises an electrically conductive cord extending between the control unit and the at least one massager module.

As will be realized, the invention is capable of other and different embodiments and its several details are capable of modifications in various respects, all without departing from the invention. Accordingly, the drawings and description are to be regarded as illustrative and not restrictive.

### BRIEF DESCRIPTION OF THE DRAWINGS

FIG. 1 is a schematic view illustrating a massage system used in various preferred embodiment mats or pads according to the present invention.

FIG. 2 is a schematic view of a preferred embodiment massaging foot mat in accordance with the present invention.

FIG. 3 is a schematic view of a preferred embodiment massaging seat bottom and seat back in accordance with the present invention.

FIG. 4 is an illustration of another preferred embodiment massaging foot mat in accordance with the present invention.

### DETAILED DESCRIPTION OF THE EMBODIMENTS

The present invention relates to a therapeutic mat or pad which provides therapeutic relief in the form of vibratory massage and optionally, in combination with the emission of heat. The therapeutic mat or pad can be provided in several different forms, for example as a mat adapted for placement of a user's foot or feet thereon, or as a component of a seating unit, such as for example as a seat bottom or seat back. Preferably, the therapeutic mat or pad is adapted for use in a vehicle cabin, such as within the interior of an automobile or like vehicle, and so includes provisions for powering the therapeutic mat from the power system of the vehicle. These aspects and others are detailed herein.

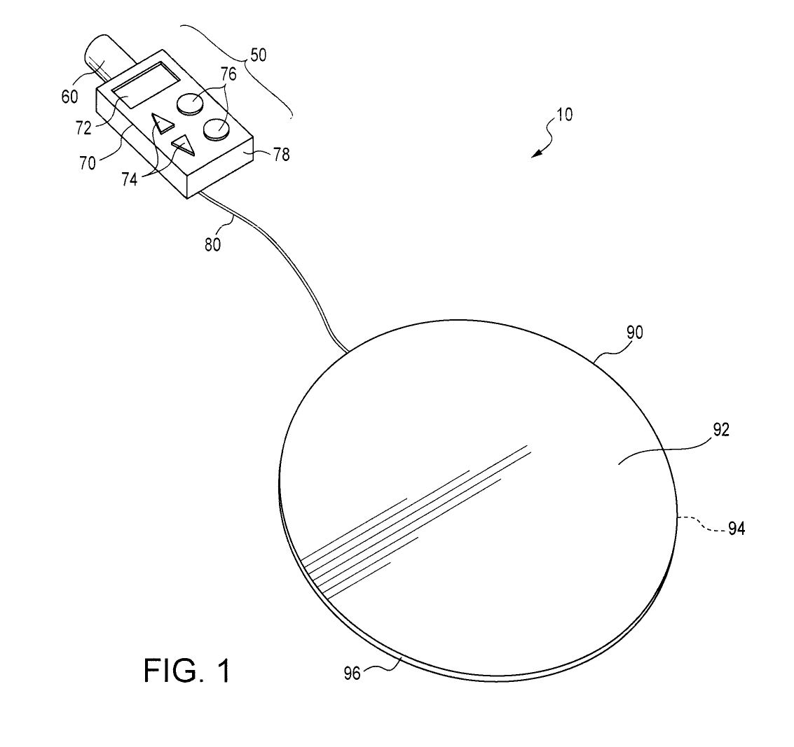

FIG. 1 is a schematic illustration of a massage system 10 used in a preferred embodiment therapeutic mat or pad, examples of which are described herein. The massage system 10 comprises a control and/or power unit 50 which includes a power plug 60 and/or adaptor module and a control unit 70. The control/power unit 50 is preferably in the form of a conventional 12 volt direct current (VDC) plug or adapter. The control unit 70 may be provided with an array of features including for example, but not limited to, an indicator 72, one or more control elements 74, one or more on/off elements 76, and a housing 78. The control unit 70 preferably is a microprocessor-based electronic unit which governs operation of one or more components used in the massage system 10 and/or the therapeutic mat for example. The indicator 72 provides information to the user such as the status of the device(s), desired temperature (in the event that heating elements are provided), actual temperature, operation levels, status codes, etc. It will be appreciated that the control unit 70 is not limited to these features.

The massage system 10 also includes a massager module 90 which may be in a variety of different forms, shapes, and configurations. A preferred form for the massager module 90 used in the system 10 is a relatively flat, planar, flexible member. The module 90 may also be in a variety of different shapes such as circular, oval, square, rectangular, polygonal, . . . etc. The module 90 is depicted in a circular shape in the accompanying figures. The module 90 defines a first face 92, an oppositely directed second face 94, and an edge 96 extending between the faces 92 and 94 and generally defining the outer perimeter of the module 90.

The massage system 10 further includes a power and/or communication cord 80 extending between the control/power unit 50 and the massager module 90. The cord 80 preferably is a multi-conductor cord and is adapted to provide electrical power to one or more powered devices utilized in the therapeutic mat or pad, such as the massager module 90, and/or one or more electrical heating elements. The cord 80 may also include one or more electrical conductors for providing or receiving electrical control signals used in the operation of the massager module 90 and/or heating elements. For example, temperature sensors may be provided in the mat which can provide electrical signals to the control unit 70 for governing the operation of the mat. It is also preferred that the power cord include appropriate insulation and in certain applications, a protective sheathing along its length.

It is also contemplated that one or more connectors can be provided in conjunction with the cord 80 to provide selectable connection and removal of either or both of the control/power unit 50 and the massager module 90 from the cord 80.

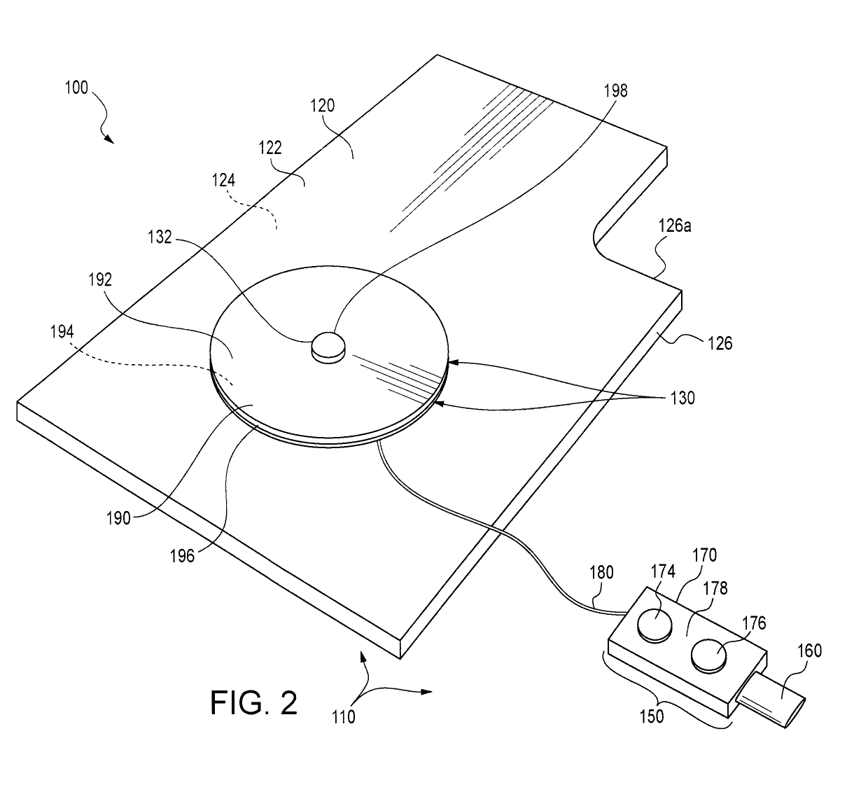

FIG. 2 is a schematic illustration of a preferred embodiment massaging foot mat 100 in accordance with the present invention. The mat 100 comprises a massage system 110. The massage system 110 generally corresponds to the previously described massage system 10. In this regard, it will be appreciated that the previous description for components of the system 10 applies to components of the system 110 having like numbering.

The massage system 110 includes a control/power unit 150 which preferably comprises a 12 VDC plug/adapter 160, and a control unit 170. The adapter or plug is preferably a male plug adapted to be inserted within and engage a female connector such as a vehicle cigarette lighter receptacle. The control unit may include one or more control elements 174, one or more on/off elements 176, and a housing 178. Although not specifically depicted, it will be understood that the control unit 170 may also include one or more indicator(s) for presenting information to the user.

The massage system 110 of the massaging foot mat 100 also preferably comprises a power/communication cord 180 extending from the control/power unit 150.

The massage system 110 of the massaging foot mat 100 also comprises one or more massager modules 190. In the version depicted in FIG. 2, the mat includes a single massager module 190. The one or more massager modules are preferably incorporated within a hollow interior region of the mat. As explained in greater detail herein, the massage module is preferably inserted in the hollow interior of the mat through one or more closure assemblies along a face of the mat. For example, a zippered opening could be provided on either a top or bottom face of the mat. The massage module could be accessed through the zippered opening. The module 190 defines an upwardly directed first face 192, an oppositely directed second face 194, and an edge 196 extending between the faces 192 and 194 and generally defining the outer periphery of the module 190. Preferably, the massager module 190 further includes one or more outwardly projecting members or “bumps” 198 for providing therapeutic massage action and in particular to select regions of a user's feet. In the embodiment depicted in FIG. 2, a single upwardly projection 198 is provided for reaching the arch region of a user's foot. It will be appreciated that the present invention is in no way limited to the particular configuration depicted in FIG. 2.

A human foot is characterized as having a transverse arch extending in a width direction along an underside of the foot, and a longitudinal arch extending in a length direction also along the underside of the foot. These concave regions along the underside of the foot are generally not accessible by flat massaging surfaces, or even planar surfaces with massaging “fingers” as known in the art. Provision of the outwardly projecting region or member 198 of the massage module 190 enables these regions of a user's feet to be contacted with and receive therapeutic massaging relief. Accordingly, the preferred embodiment mat includes one or two outwardly projecting members such as member 198, each of which is sized, shaped, and configured to reach and contact the concave arch regions along the underside of a human foot.

The massaging foot mat 100 also includes a mat 120. The mat is preferably in the form of a relatively thin, planar, flexible member adapted to reside along the floor, and particularly along the floor of an automotive or vehicle cabin. The mat may be formed from a wide array of materials and can utilize a single or multilayer construction. The mat defines an upwardly directed first face 122, an oppositely directed second face 124, and an edge 126 extending between the faces 122 and 124. For applications in which the massaging floor mat 100 is provided as a vehicle floor mat, the mat 120 can be in a shape corresponding to the shape of the floor region to receive the mat, and/or to accept components within the vehicle interior such as a gas pedal. The foot mat 100 is illustrated in FIG. 2 as featuring an inset edge region 126a, such as for accommodating a gas pedal when the foot mat 100 is used on the driver's side within a vehicle cabin.

A significant and preferred feature of the massaging foot mat 100 is a massager module access and retention system 130. The retention system releasably retains the one or more massager modules 190 in association with the mat 120. It will be appreciated that the mat 100 includes the massager module 190 within the interior of the mat, and thus the module 190 would not be visible from the mat exterior. FIG. 2 is schematic in nature and illustrates the module 190 for ease in understanding the invention. As explained herein, the module 190 is accessible and can be removed from or re-introduced into the mat 100 through one or more access and retention provisions provided along a region of the mat. The module access and retention system 130 can be provided in a wide variety of different configurations. One preferred configuration is depicted in FIG. 2, in which a pocket or other recessed region is defined in the mat 120 and preferably along the upwardly directed face 122 of the mat. The pocket or recessed region is sized and shaped to receive and accommodate the one or more massager modules 190. The module access and retention system 130 also preferably includes provisions for selectively accessing and/or retaining the module(s) 190 in the pocket or recessed region. An example of such provisions is a zipper extending entirely or partially along an edge region of the pocket. Upon appropriate placement and positioning of the massager module(s) in the pocket, the zipper can be closed to thereby conveniently enclose and retain the massager module(s) 190 in the mat 120. Other access and retention systems are contemplated such as for example, buttons, Velcro or hook and loop fasteners, and adhesive systems.

The mat 120 may optionally also be provided with one or more apertures through which the previously described therapeutic projection(s) 198 may extend. Thus, the projection(s) 198 may directly contact the underside of a user's foot. It will be understood that the aperture(s) are sized, shaped, and located corresponding to the size, shape, and location(s) of the therapeutic projection(s).

As previously noted, in one embodiment, the one or more projections 198 can be included with or extend from the massager module 190. In this version of the invention, provisions are included in the mat 120 to accommodate the projections 198, such as apertures or other structures in the mat which cooperate with the projections so that the projections can transmit vibratory motion directly from the module 190 to a user in contact with the projections. Alternatively, the invention includes forming or providing the one or more projections 198 as part of the mat 120 and locating such projections so that vibratory motion from the module 190 can be effectively transmitted thereto.

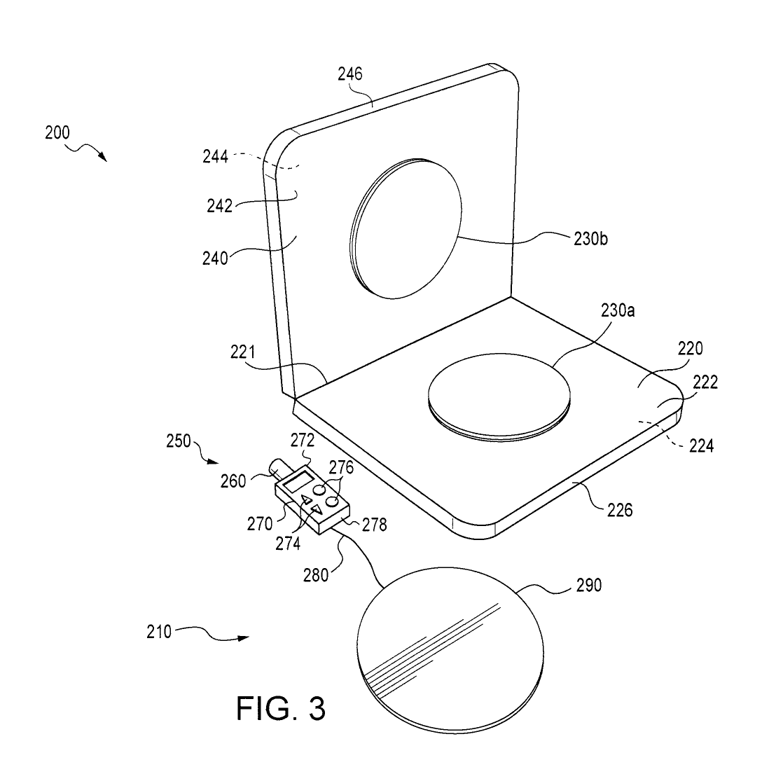

FIG. 3 schematically depicts yet another embodiment according to the present invention. In this version of the present invention, a massaging seat system 200 is provided. The system 200 comprises a massage system 210, similar or identical to the previously described massage systems 10, 110. As previously noted, respective components of the massage system 210 correspond to components of the systems 10, 110 having like reference numbers. Generally, the massage system 210 includes a control/power unit 250 having a 12 VDC plug/adapter 260 and a control unit 270. The control unit 270 includes an indicator 272, one or more control elements 274, one or more on/off elements 276, and a housing 278. The massage system 210 also includes one or more massager modules 290, and a power/communication cord 280 extending between the control unit 270 and the massager module(s) 290.

The massaging seat system 200 further comprises one or more components of a seat, preferably a seat adapted to be used in a vehicle or the like, such as for example a seat bottom 220 and/or a seat back 240. It will be appreciated that the seat system 200 may comprise both a seat bottom 220 and a seat back 240; a seat bottom 220 by itself; or a seat back 240 by itself. Furthermore, it will be appreciated that for a version of the massaging seat system 200 in which both a seat bottom 220 and a seat back 240 are provided, the bottom and back may be formed such that they are permanently attached or releasably attached to one another such as along region 221.

Furthermore, in accordance with the present invention, it is contemplated that the seat bottom 220 and/or the seat back 240 may be formed as integral components of a seat assembly, such as for example, an automotive seat assembly. Alternatively, the seat bottom 220 and seat back 240 may be provided as auxiliary, add-on components which may be permanently or temporarily attached to the appropriate faces of a seating assembly.

Referring further to FIG. 3, the seat bottom 220 defines an upwardly directed first face 222, an oppositely directed second face 224, and an edge 226 extending therebetween. Similarly, the seat back 240 defines a frontwardly directed first face 242 an oppositely directed second face 244, and an edge 246 extending therebetween.

Preferably, both the seat bottom 220 and the seat back 240 include provisions for retaining one or more massager module(s) 290. These provisions may in many instances, be the same or similar as the access and retention provisions 130 described and shown in FIG. 2. Thus, for example the seat bottom 220 preferably includes a massage module retention system 230a; and the seat back 240 preferably includes a massage module retention system 230b. Preferably, each of these systems 230a and 230b are in the form of a pocket or recessed region in the respective seat bottom 220 and/or seat back 240 having a zippered region for releasably retaining one or more massager module(s) 290 positioned within the pocket or recessed region. Again, it will be understood that FIG. 3 is in schematic form showing the modules 230a and 230b. In reality, the modules would not be visible since they are retained within the interior of the seat bottom and back 220, 240.

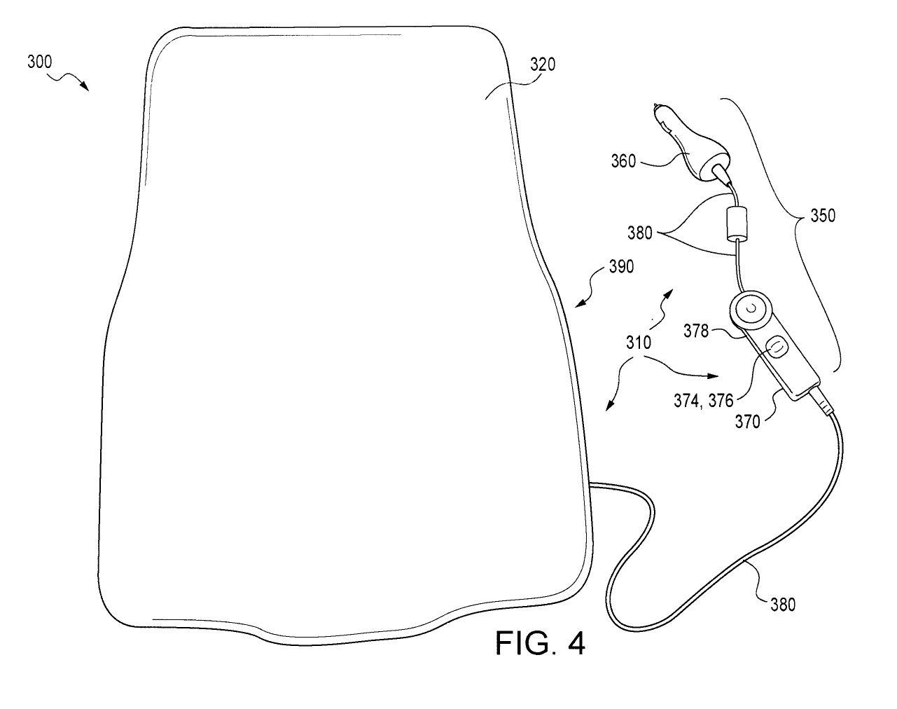

FIG. 4 illustrates another preferred embodiment massaging mat 300 in accordance with the present invention. The massaging mat 300 preferably comprises a mat 320 which depending upon the particular intended application, may be adapted for use as a floor mat in a vehicle cabin. The massaging mat 300 comprises a massage system 310. The massage system 310 is the same or similar as previously described massage systems 10, 110, and 210; with corresponding components using like reference numbers. Generally, the massage system 310 includes a control/power unit 350 which comprises a 12 VDC plug/adapter 360 and a control unit 370. The control unit 370 may include one or more control elements 374, one or more on/off elements 376 and a housing 378. A power/communication cord 380 extends between the control/power unit 350 and a massager module 390. The module 390 (not shown) is incorporated within the mat 320. The cord 380 or a portion thereof may also extend between the 12 VDC plug/adapter 360 and the control unit 370.

The present invention therapeutic mat or pad also may include one or more additional therapeutic components. A preferred example of such a component is an electrically operated resistive heating element. Thus, one or more heating elements could be incorporated in the massaging mats 100 and 300, or in the massaging seat system 200. The one or more resistive heating element(s) can be in nearly any shape, size, and/or configuration. However, it is preferred for most applications that the resistive heating element(s) be in the form of thin, flexible strips. The resistive heating elements are preferably permanently incorporated in the massaging foot mat or massaging seat system; however the invention includes versions in which the heating elements can be removed from the mat or system, such as for example to allow for replacement or washing of the mat or system. For versions in which the heating elements can be removed from a mat, it is contemplated that the heating elements can be accessed and/or removed either separately or collectively with the previously described massager modules.

The preferred embodiment mats can be formed using constructions, materials, and components described in the prior art, such as for example in one or more of U.S. Pat. Nos. 2,476,921; 3,100,483; 4,326,506; 4,329,981; 5,254,384; 5,490,821; 5,628,079; 6,579,250; and 7,297,126. In addition, various vibration-providing components and heating systems are known in the art, commercially available, and potentially eligible for use in the preferred embodiment mats described herein. For example, flexible heating elements and controllers are available from Birk Manufacturing of East Lyme, Conn.; and Watlow of St. Louis, Mo.

Although the present invention has been described in terms of a floor mat and a seating system; it will be understood that the present invention can be provided in numerous other forms and configurations. Furthermore, although the floor mats and seating systems are primarily described in terms of application within a vehicle cabin or interior, it will be appreciated that the present invention is not limited to such applications.

Many other benefits will no doubt become apparent from future application and development of this technology.

All patents, published applications, and articles noted herein are hereby incorporated by reference in their entirety.

As described hereinabove, the present invention solves many problems associated with previous type devices. However, it will be appreciated that various changes in the details, materials and arrangements of parts, which have been herein described and illustrated in order to explain the nature of the invention, may be made by those skilled in the art without departing from the principle and scope of the invention, as expressed in the appended claims.

What is claimed is:

1. A vehicle floor mat, the mat comprising:
a thin, planar, flexible member defining an upwardly directed first face, an oppositely directed second face, and an interior hollow region between at least a portion of the first face and the second face, the first face defining at least one raised region, the flexible member sized and shaped to reside along the floor of a vehicle cabin;
a massager module disposed in the interior hollow region of the flexible member, the module emitting vibratory motion upon application of electrical power to the module;
a control unit for controlling the operation of the massager module;
an electrically conductive cord extending between the massager module and the control unit;
wherein the massager module includes at least one outwardly extending member that directs vibratory motion to the at least one raised region of the first face of the flexible member.

2. The vehicle floor mat of claim 1 wherein the flexible member includes an assembly for providing selective access to the interior hollow region of the flexible member.

3. The vehicle floor mat of claim 2 wherein the assembly is a zippered assembly along the first face of the flexible member that provides access to the interior hollow region of the flexible member.

4. The vehicle floor mat of claim 1 wherein the control unit includes an adapter to connect the control unit to a power system in a vehicle.

5. The vehicle floor mat of claim 4 wherein the adapter is a male adapter configured to be inserted within and engage a vehicle cigarette lighter receptacle.

6. The vehicle floor mat of claim 1 further comprising:
a heating element disposed in the flexible member, the heating element emitting heat upon application of electrical power to the heating element.

7. The vehicle floor mat of claim 6 wherein the control unit also controls the operation of the heating element.

8. An electrically powered therapeutic mat, the mat comprising:
a thin, planar, flexible member defining a first upwardly directed face and a second oppositely directed face, the flexible member further defining a hollow interior region between at least a portion of the first face and at least a portion of the second face, the flexible member including an assembly providing selective access to the interior region from at least one of the faces, the flexible member further including at least one upwardly extending projection along the first face of the flexible member;
a massager module disposed in the interior region defined in the flexible member;
a heating element disposed in at least a portion of the flexible member; and
a control unit in communication with both the massager module and the heating element and configured for controlling the operation of each of the massager module and the heating element.

9. The mat of claim 8 wherein the assembly for providing selective access to the interior region of the flexible member is a zipper assembly.

10. The mat of claim 8 further comprising:
an adapter to connect to a power system in a vehicle.

11. A mat adapted for placement on a vehicle seat, the mat comprising:
a thin, planar, flexible member sized and shaped to conform and be positioned on a vehicle seat, the flexible member defining a seat portion for placement on a seat cushion of the vehicle seat and a back portion for placement on a back cushion of the vehicle seat, the member defining a selectively accessible interior hollow region in at least one of the seat portion and the back portion of the flexible member;
at least one massager module disposed in the at least one interior hollow region defined in the flexible member, the module emitting vibratory motion upon application of electrical power to the module;
a control unit for controlling the operation of the at least one massager module; and
an electrically conductive cord extending between the control unit and the at least one massager module.

12. The mat of claim 11 wherein the mat comprises a massager module disposed in the interior hollow region defined in the seat portion of the flexible member.

13. The mat of claim 11 wherein the mat comprises a massager module disposed in the interior hollow region defined in the back portion of the flexible member.

14. The mat of claim 12 wherein the massager module in the seat portion of the flexible member is a first massager module, the mat further comprising a second massager module disposed in the back portion of the flexible member.

15. The mat of claim 11 further comprising:
at least one heating element disposed in at least one of the seat portion and the back portion of the flexible member, the at least one heating element being controlled by the control unit.

16. The mat of claim 15 wherein the mat comprises a first heating element in the seat portion of the flexible member and a second heating element in the back portion of the flexible member.
